(19) United States
(12) Patent Application Publication
(10) Pub. No.: US 2012/0327674 A1
(43) Pub. Date: Dec. 27, 2012

(54) VEHICLE VISOR HAVING HIDDEN LIGHT ASSEMBLY

(76) Inventors: John Andrew Stakoe, Bloomfield Hills, MI (US); Chi Li, Farmington Hills, MI (US)

(21) Appl. No.: 13/167,326

(22) Filed: Jun. 23, 2011

(51) Int. Cl. B60Q 3/06

(52) U.S. Cl. 362/492

(57) ABSTRACT

A vehicle visor is provided that includes a visor body having a first side, a second side, and a light transmissive cover material. The vehicle visor further includes a hidden light assembly located in the visor body arranged to provide light illumination through the light transmissive cover material on the first and second sides of the visor body.

### FIELD OF THE INVENTION

The present invention generally relates to automotive lighting in a vehicle, and more particularly relates to a vehicle visor assembly equipped with lighting.

### BACKGROUND OF THE INVENTION

Automotive vehicles are commonly equipped with a pair of sun visors generally connected to the roof or headliner forward of the driver and front passenger seats. Each visor may be actuatable between stowed and use positions to provide shade from sunlight. The conventional visor typically includes a vanity mirror and light assembly installed on one side of the visor body. The vanity mirror and light assembly typically has a mirror and one or more vanity lights and lenses to provide local lighting sufficient to enable a user to view an image in the mirror, particularly when ambient lighting conditions are poor. The vanity light(s) is activated on typically when the visor is in the use position and a lid of the vanity assembly is opened or uncovered. It would be desirable to provide lighting in a visor in a manner that achieves reduced package space.

### SUMMARY OF THE INVENTION

According to one aspect of the present invention, a vehicle visor includes a visor body having a first side and a second side. The visor body has a light transmissive cover material. The vehicle visor further includes a light assembly located in the visor body arranged to provide light illumination through the light transmissive cover material on the first and second sides of the visor body.

According to another aspect of the present invention, a vehicle visor is provided that includes a visor body having a first side and a second side and a light transmissive cover material on both the first and second sides. The visor also includes a lighting device assembly located in the visor body and arranged to provide light illumination through the light transmissive cover material on the first and second sides of the visor body. The lighting device assembly provides first light illumination through the first side to serve as a vanity mirror light and provides second light illumination through the second side to serve as one of a reading and dome light.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is a perspective view of a sun visor in a stowed position in a vehicle and having a hidden light assembly, according to one embodiment;

FIG. 1A is a cross-sectional view taken through line IIA-IIA of FIG. 1 further illustrating the light assembly;

FIG. 1B is an enlarged view of section IB of FIG. 1A;

FIG. 2 is a perspective view of the sun visor in the downward use position with the vanity assembly lid in the covered position;

FIG. 2A is a cross-sectional view taken through line IIA-IIA of FIG. 2 further illustrating the light assembly;

FIG. 3 is a perspective view of the sun visor in the downward use position with the vanity lid in the open uncovered position;

FIG. 3A is a cross-sectional view taken through line IIIA-IIIA further illustrating the light assembly;

FIG. 3B is an enlarged view of section IIIB of FIG. 3A; and

FIG. 4 is a sectional view taken through a visor having a hidden light assembly with a circuit board with light sources on opposite sides, according to another embodiment.

### DETAILED DESCRIPTION OF PREFERRED EMBODIMENTS

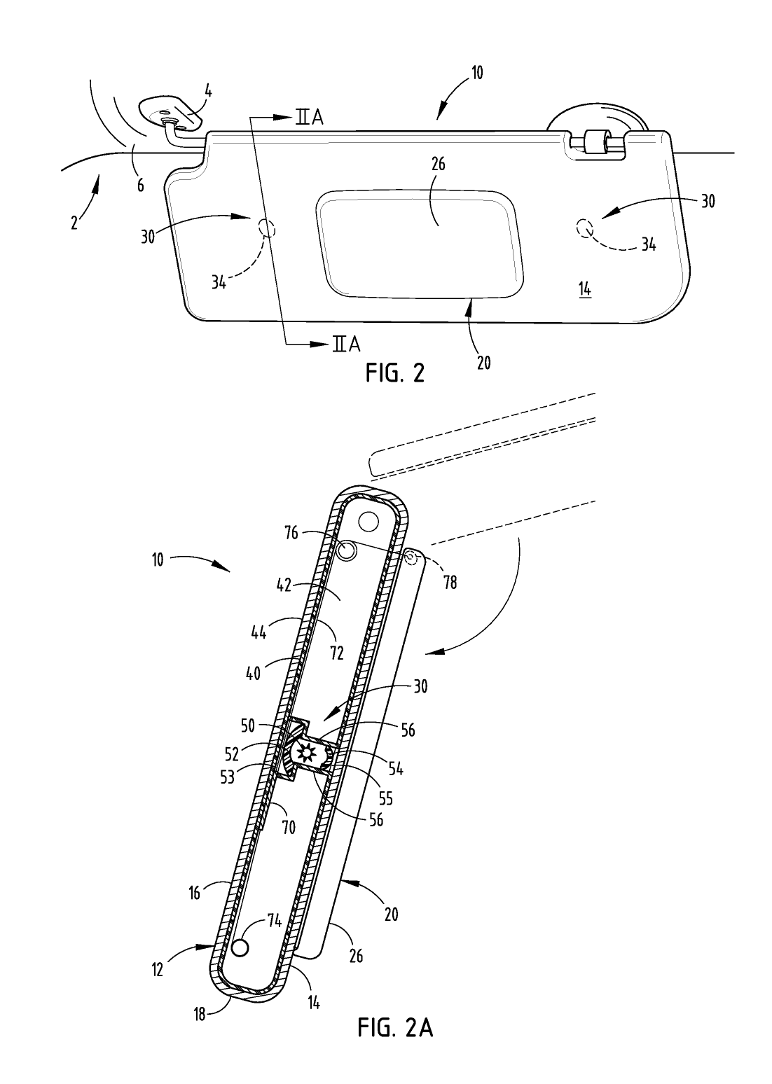

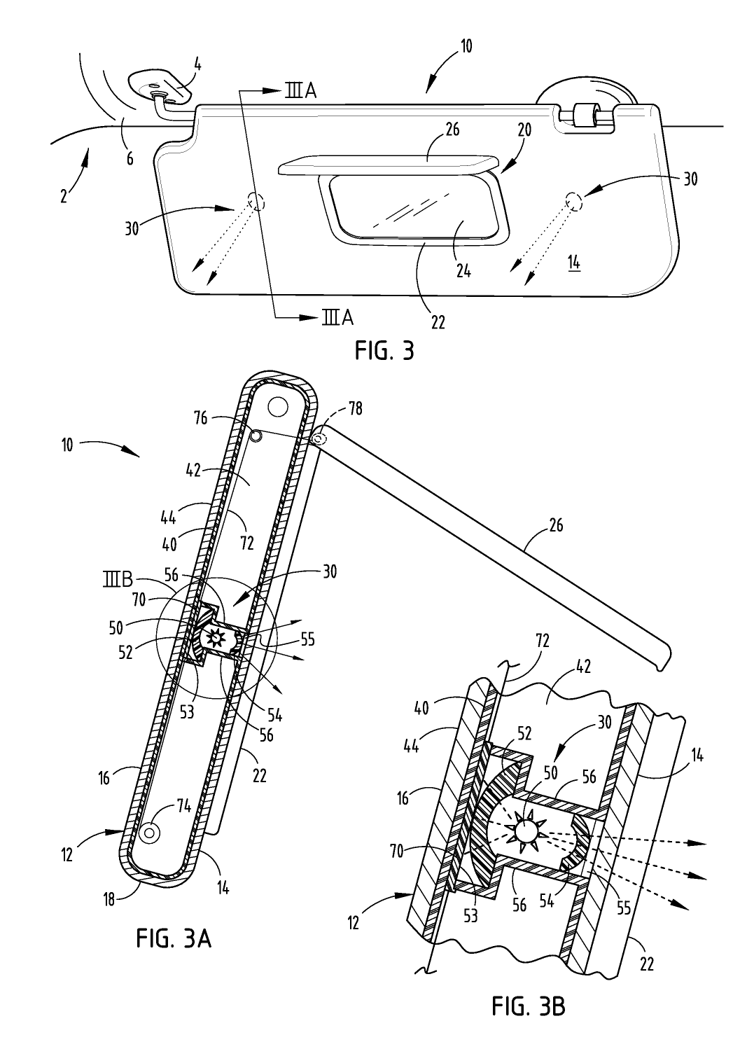

For purposes of description herein, the terms “upper,” “lower,” “right,” “left,” “rear,” “front,” “vertical,” “horizontal,” and derivatives thereof shall relate to the visor and lighting assembly as oriented in FIGS. 2 and 3. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

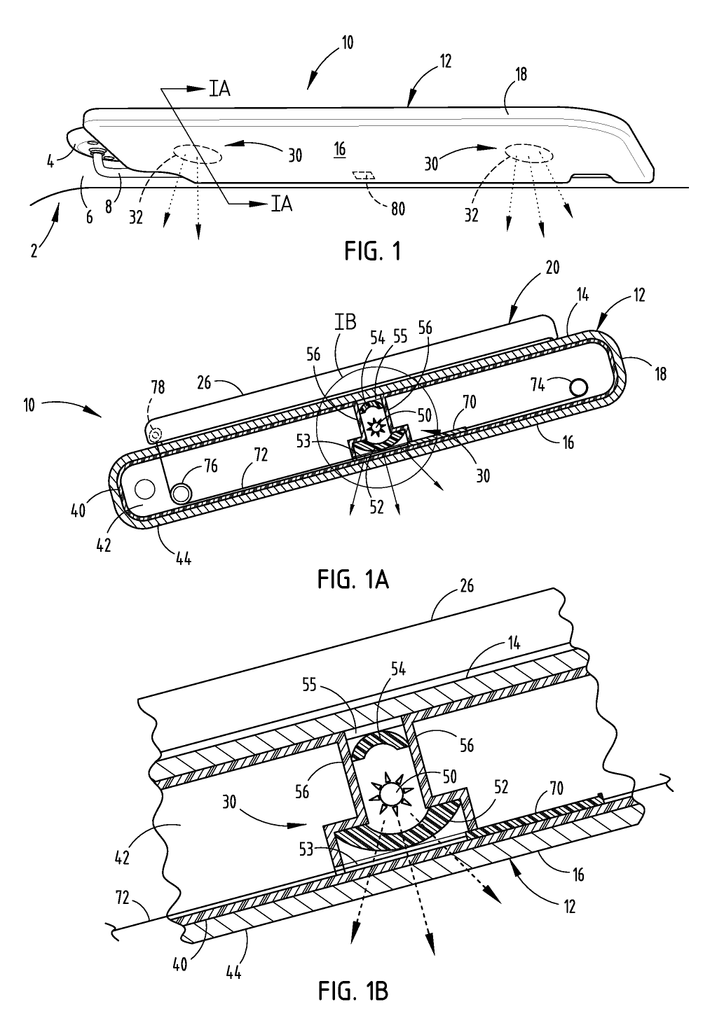

Referring to FIGS. 1-3A, a vehicle sun visor 10 is generally shown having a hidden light assembly 30 configured to provide light illumination on both sides of the visor 10, according to a first embodiment. The vehicle sun visor 10 is shown installed in a passenger compartment of a vehicle 2 generally in a region forward of a front passenger seat of the vehicle 2. The visor 10 has a visor body 12 with a pivoting connector 8 that connects to a roof mounted bracket 4 generally in the headliner 6 or roof of the vehicle 2. It should be appreciated that one or more sun visors 10 may be located at any of a number of locations in the vehicle 2 and may be employed on any of a number of types of vehicles to provide sunshade in various positions including blocking light from the front windshield or from a side window which may be achieved by pivoting the visor body about connector 8. The sun visor 10 is designed to be tilted upright to a generally horizontal stowed position as shown in FIG. 1, or may pivot downward to a generally vertical deployed use position as shown in FIGS. 2 and 3.

The vehicle sun visor 10 includes a visor body 12 generally having a conventional visor shape with a first or front side 14, a second or rear side 16 generally parallel to and opposite of first side 14, and a peripheral edge 18 connecting the first side 14 to the second side 16. The visor body 12 may be made of conventional visor materials including, but not limited to, polyurethane and fabric. The pivoting connector 8 extends from the visor body 12 and connects the visor 10 to the roof mounted bracket 4 and allows the visor body 12 to be pivoted between the stowed position shown in FIG. 1 and downward use position shown in FIGS. 2 and 3, and also to be rotated about ninety degrees (90°) from a position generally in front of the vehicle front windshield and a position generally in front of a side window of the vehicle 2.

The visor 10 employs a pair of light assemblies 30 disposed within the visor body 12, generally within a hollow core of the visor body 12. Each light assembly 30 includes one or more light sources for providing light illumination passing through a fabric covering on the first side 14 of visor body 12 and for providing light illumination passing through the fabric covering on the second opposite side 16 of visor body 12. Each light assembly 30 may serve to provide map or dome lighting projecting from the second or rear side 16 of the visor body 12 when the visor 10 is in the upward stowed position as shown in FIG. 1. In the visor stowed position, the light sources may be activated on (turned on) in response to a switch, such as a door open switch or a user actuated switch 80 mounted on the second side 16 of the visor to serve as a dome/reading light within the vehicle 2. The light sources may also be activated on in response to a user input so as to function as map or reading lights to enable a passenger in the vehicle to read or view maps, text and other reading materials. The light assembly 30 also provides light illumination through the fabric covering 44 on the first or front side 14 of the visor body 12 as shown in FIG. 3 to provide lighting to enable a user to view a vanity mirror.

Assembled onto the front side 14 of the visor body 12 is a vanity mirror assembly 20 which includes a molded base 22 having a vanity mirror 24. The vanity assembly 20 also includes a vanity lid 26 pivotally connected to the top edge of the molded base 22 via pivot connectors such that the lid 26 is pivotable between a covered position shown in FIG. 2 which covers the mirror 24 and an uncovered position shown in FIG. 3 which exposes the mirror 24. The vanity lid 26 may be coupled to switch circuitry which turns the light assemblies 30 on when the vanity lid 26 is opened to provide vanity lighting and turns the light assemblies 30 off when the vanity lid 26 is closed as should be apparent to one skilled in the art. The lights in the vanity side are activated by the vanity lid 26 while the dome/reading lights are controlled by a separate switch 80 mounted on the second side 16 of the visor. The dome/reading lights on the second side 16 (FIG. 1) could also be remotely controlled by the vehicle door opening courtesy circuit or other remotely mounted lighting switches. Thus, the light assemblies 30 provide light illumination to the fabric covering 44 on the front side 14 to a passenger in the vehicle 2 when the vanity lid 30 is in the open uncovered position.

Referring to FIGS. 1A and 1B, the visor 10 is illustrated having a visor body 12 generally made of a structurally supportive substrate 44. The visor substrate 44 may include a polypropylene clamshell having a hollow interior or core 42, according to one embodiment. The visor body 12 further includes a light transmissive or light permeable fabric covering 44 which contacts and surrounds or covers the substrate 40. The fabric covering 44 provides a pleasant appearance and feel to the visor body 12. The fabric covering 44 covers and hides the light assemblies 30 from view, yet has light transmissive properties that enable a portion of the light waves to be transmitted or permeate through the fabric covering 44 to enable light from within the interior of the visor body 12 to be illuminated through the fabric covering 44. According to one embodiment, the fabric covering 44 has a light wave transmissivity or permeability in the range of ten to thirty percent (10 to 30%), and more preferably about twenty-five percent (25%), according to one embodiment. The fabric covering 44 may be formed as a woven knit cloth or fabric. The fabric covering 44 may include a polyester fiber, according to one embodiment. It should be appreciated that other light transmissive covering materials may be employed that allow light to be transmitted therethrough so as to provide hidden lighting assemblies 30 such that the lighting assemblies 30 are is not readily visible from outside the visor body 12, yet provide light illumination exterior to the visor body 12.

Disposed within the visor body 12 is the pair of light assemblies 50, shown located on left and right sides of the vanity mirror assembly 20. The left and right side locations of the light assemblies 30 is particularly well suited for a flip-type vanity mirror assembly 20 as shown; however, it should be appreciated that the light assemblies 30 may be located elsewhere in the visor body 12, such as above or below the vanity mirror assembly 20, particularly for a sliding lid vanity mirror assembly. The light assemblies 30 each are configured to provide light illumination through the light transmissive fabric covering 44 on the second side 16 of visor body 12 when the visor is in the stowed position so as to serve either as a dome lamp or a reading/map lamp. Each of the lighting assemblies 30 may also provide light illumination through the light transmissive fabric covering 44 on the first side 14 as shown in FIG. 3 when the visor body 12 is in the downward use position and the vanity lid 26 is uncovered so as to provide vanity lighting.

Each light assembly 30 includes a light source 50 disposed within the interior hollow core 42 of the visor body 12. Each light source 50 may include one or more light emitting diodes (LEDs), according to one embodiment. However, it should be appreciated that other light sources such as incandescent bulbs and fluorescent lights may be employed to provide the source of light illumination. Each light assembly 30 also includes a light shield 56 extending generally through the visor body thickness from the first side 14 to second side 16 within the hollow core 42 so as to shield the light waves and direct the light illumination within a window generally toward the first side 14 and a window towards the second side 16 of the visor body 12 and prevent light waves from scattering transverse within the hollow core 42. Thus, the light shield 56 serves as a light chamber, according to one embodiment. The inside surface of the light shield 56 may have a reflective surface to reflect the light rays. The shield 56 may be configured as a light pipe, according to another embodiment.

Each light assembly 30 further includes a pair of lenses 52 and 54 provided on opposite first and second sides 14 and 16 of the visor body 12 for focusing light illumination in a desired path through light output portions of the light transmissive fabric covering 44. First lens 52 is disposed between the fabric covering 44 and light source 50 in a region where a cutout or opening 53 in the visor substrate 40 is provided, such that light illumination from light source 50 is directed by lens 52 through the opening 53 in substrate 40 so as to pass through a generally defined area of light transmissive fabric covering 44 to serve as a dome light or reading/map for use by a passenger in the vehicle. The second lens 54 is disposed between the light source 50 and fabric covering 44 on the first side 14 of the visor body 12 at a location where a portion of the substrate 40 is cutout 55 to form an opening. As such, light illumination from light source 50 is directed via lens 54 through the cutout 55 in substrate 40 and directed through a defined region of the light transmissive fabric covering 44 into the interior of the vehicle so as to serve as a vanity light to provide light illumination to a user in the vehicle to aid with the use of the vanity mirror. It should be appreciated that the lens 52 may be larger than lens 54 so as to provide enhanced light concentration for use as a dome or a map/reading light, as compared to lens 54 which generally requires less light intensity as a vanity light.

Referring to FIGS. 3A and 3B, the visor 10 is further illustrated employing a light shield assembly having a cable 72 and cam 78 arrangement to provide a light shield 70 that covers the light illumination output 32 on the second side of the visor body 12 when the visor body 12 is in the downward use position and the vanity lid 26 is open (uncovered) such that the vanity light is activated on. By shielding light illumination on the rear side 16 of the visor body 12, light illumination is prevented from projecting forward through the vehicle windshield when the visor body 12 is in the downward use position. The light shield assembly employs the light shield 70 as a movable plate or member that may move into position in front of lens 52 to block light illumination from the second side 16 of visor body when the vanity lid 26 is open. The light shield 70 is moved to a position away from the front side of lens 52 when the vanity lid 26 is closed so as to allow for light illumination for dome or map/reading lights. The light shield assembly is shown employing a cam 78 at the pivot of vanity lid 26 which pulls cable 72 about pulleys 76 and 74 so as to slidably move light shield 70. It should be appreciated that pulley 74 may include a coil spring to provide an opposite force when cam 78 retracts during closure of the vanity lid 26. It should be appreciated that other light shield assembly arrangements may be provided for providing a shield on the second side 16, according to other embodiments.

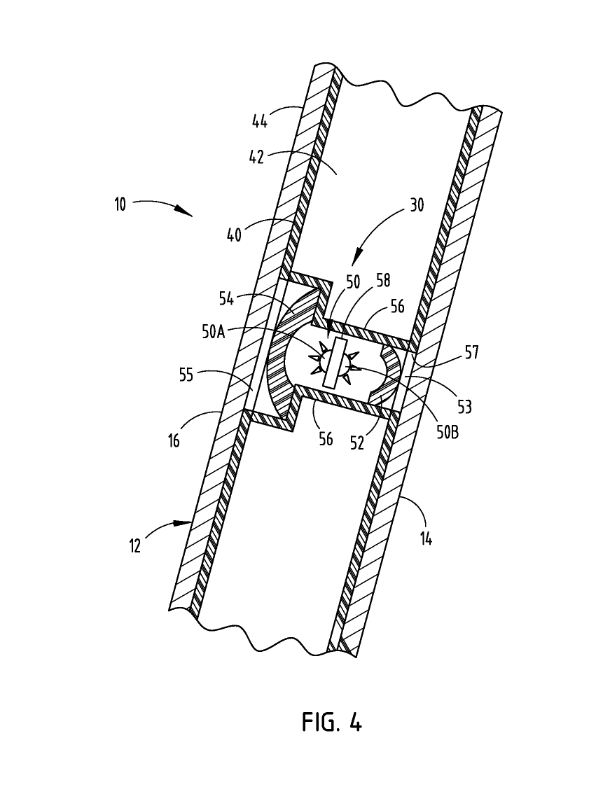

Referring to FIG. 4, a lighting assembly 50 employed in the visor 10 is illustrated according to a second embodiment. In this embodiment, the light assembly 30 includes a light source 50 that includes first and second LEDs 50A and 50B located on opposite sides of a circuit board 58. The first LED 50A provides light illumination through lens 54 and the fabric covering 44 to provide light illumination 32 on the second side of the visor body 12. The second LED 50B provides light illumination through lens 52 and fabric covering 44 to provide light illumination 34 on the first side of the visor body 12. In this embodiment, the first and second LEDs 50A and 50B may be controlled independent of each other such that only one of the LEDs 50A or 50B is turned on at a time, thereby eliminating the need for any shielding on the rear side of the visor body 12. While a first LED 50A is shown provided for providing light illumination on one side and second LED 50B is shown for providing light illumination on the opposite side, it should be appreciated that one or more light sources may be employed on each side of circuit board 58 to provide the light illumination for each light assembly 30.

Accordingly, the vehicle visor 10 advantageously provides for hidden light assemblies 30 within a visor body 12 that allows for lighting on both sides of the visor. The light assembly is able to provide both dome or map/reading lights on one side of the visor body and vanity lighting on the opposite side of the visor body. The hiding lights provide an enhanced perception appearance may be achieved with the visor 10.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A vehicle visor comprising:
a visor body having a first side and a second side, the visor body having a light transmissive cover material; and
a light assembly located in the visor body arranged to provide light illumination through the light transmissive cover material on the first and second sides of the visor body.

2. The visor of claim 1, wherein the light assembly is configured to provide a first light illumination on the first side of the visor body and is configured to provide a second light illumination on the second side of the visor body.

3. The visor of claim 2, wherein the first light illumination comprises a vanity light and the second light illumination comprises a reading light.

4. The visor of claim 3, wherein the first and second light illuminations are selectively provided one at a time.

5. The visor of claim 1, wherein the vehicle visor further comprises a vanity mirror assembly located on the first side of the visor body.

6. The visor of claim 5, wherein the vanity mirror assembly has a flip lid that pivots between covered and uncovered positions, wherein the light assembly is activated when the vanity lid pivots to the uncovered position.

7. The visor of claim 6, wherein the vanity mirror assembly further comprises a light shield located on the visor body so as to shield light from the second side of the visor body when the visor body is in a downward use position.

8. The visor of claim 1, wherein the light assembly comprises at least one light emitting diode.

9. The visor of claim 1, wherein the light assembly comprises a first light source illuminating the first side of the visor body and a second light source illuminating the second side of the visor body.

10. The visor of claim 1, wherein the light transmissive cover material comprises polyester fiber.

11. The visor of claim 1, wherein the light transmissive cover material has a light wave permeation in the range of ten to thirty percent.

12. A vehicle visor comprising:
a visor body having a first side and a second side and a light transmissive cover material on both the first and second sides; and
a light assembly located in the visor body and arranged to provide light illumination through the light transmissive cover material on the first and second sides of the visor body, wherein the light assembly provides first light illumination through the first side to serve as a vanity mirror light and provides second light illumination through the second side to serve as one of a reading and dome light.

13. The visor of claim 12, wherein the first and second light illuminations are selectively provided one at a time.

14. The visor of claim 12, wherein the vehicle visor further comprises a vanity mirror assembly located on the first side of the visor body.

15. The visor of claim 14, wherein the vanity mirror assembly has a flip lid that pivots between covered and uncovered positions, wherein the light assembly is activated when the vanity lid pivots to the uncovered position.

16. The visor of claim 15, wherein the vanity mirror assembly further comprises a light shield located on the visor body so as to shield light from the second side of the visor body when the visor body is in downward use position.

17. The visor of claim 12, wherein the light transmissive cover material comprises polyester fiber.

18. The visor of claim 12, wherein the light transmissive cover material has a light wave permeation in the range of ten to thirty percent.

19. The visor of claim 12, wherein the light assembly comprises a first light source illuminating the first side of the visor body and a second light source illuminating the second side of the visor body.
